(19) United States
(12) Patent Application Publication
(10) Pub. No.: US 2004/0029460 A1
(43) Pub. Date: Feb. 12, 2004

(54) Actuator for a rudder propeller, in particular an electrically driven propeller of a sea-going vessel

(76) Inventors: Rainer Hartig, Hamburg (DE); Andre Korner, Buchholz I.D.N. (DE); Wolfgang Rzadki, Glinde (DE); Hannes Schulze Horn, Gladbeck (DE)

Correspondence Address: HARNESS, DICKEY & PIERCE, P.L.C., P.O.BOX 8910, RESTON, VA, 20195, US

(21) Appl. No.: 10/450,418

(22) PCT Filed: Dec. 12, 2001
(86) PCT No.: PCT/DE01/04681

(30) Foreign Application Priority Data
Dec. 14, 2000 (DE) 10062354.9

(51) Int. Cl. B60L 11/02; B60L 11/16; B60L 11/18; B63H 21/17

(52) U.S. Cl. 440/6; 114/144 RE

(57) ABSTRACT

An actuator is for a rudder propeller, in particular an electrically driven propeller of a sea-going vessel. The propeller is located on a rotative shaft in the stern region beneath the bottom of the vessel. The shaft can be rotated using at least two electric servomotors, which act by way of pinions on a rim gear that is connected to the upper part of the shaft. They preferably act by way of a gear that is located inside the upper part of the shaft and are configured to be controllable and adjustable in the group.

This application is the national phase under 35 U.S.C. § 371 of PCT International Application No. PCT/DE01/04681 which has an International filing date of Dec. 12, 2001, which designated the United States of America and which claims priority on German Patent Application number DE 100 62 354.9 filed Dec. 14, 2000 the entire contents of which are hereby incorporated herein by reference.

### FIELD OF THE INVENTION

The invention generally relates to a control drive for a steering propeller, such as a rudder propeller for example. In particular, it relates to an electrically driven steering propeller, for a seagoing vessel. Even more preferably, it relates to one which is arranged in the stern area on a shaft which can be rotated underneath the bottom of the ship.

### BACKGROUND OF THE INVENTION

Steering propellers for large ships are moved by control motors which are in general in the form of hydraulic motors. Hydraulic motors have the disadvantage that leaks can occur at the junction points between the hydraulic lines and the motors, in particular when subject to vibration loads for lengthy periods, as is the case with steering propellers. The hydraulic system that is required (pumps and motors) is relatively heavy and occupies a considerable amount of space.

In order to avoid the above disadvantages, electric control motors have already been proposed, for example in a single-motor configuration in WO 00/15495. One embodiment of an electric control motor for a large mechanical steering propeller was also already supplied by the applicant to the specialist company KAMEWA in 1998. This was an electrical control motor with a worm drive for the toothed rim of the steering propeller shaft. Worm drives such as these are self-locking and allow a high step-up ratio.

WO 89/05262, furthermore, discloses a steering propeller with two drive motors which, in the same way as the abovementioned document and the abovementioned delivery, rotate the steering propeller via a disk with an external tooth system, in which case the drive which is disclosed in WO 89/05262 and which may optionally have hydraulic motors or electric motors has two drive motors.

A similar design is also disclosed in WO 00/44617, with hydraulic motors as the control motors.

### SUMMARY OF THE INVENTION

An object of an embodiment of the invention is to specify a lightweight control drive which is more suitable for seagoing vessels than the cited prior art, in particular saving installation space, for a steering propeller.

An object may be achieved by the shaft of the steering propeller being rotated via at least two electric rotary motors which are designed such that they act via pinions on a toothed rim which is connected to the upper shaft part. Preferably, they act on a toothed rim which is arranged in the interior of the upper shaft part. For this purpose, they can be controlled and regulated jointly. This results in a particularly space-saving embodiment of a control drive for large steering propellers, in which there is no need whatsoever for any hydraulic elements.

The difficulties associated with a hydraulic system, in terms of sealing the pipe system, keeping a supply of hydraulic oil and the large amount of space required, can be avoided. The repair crew of a ship which is equipped with the control drive according to an embodiment of the invention do not need to be trained for handling and servicing hydraulic components. It is sufficient for them to know how to handle electric motors.

A refinement embodiment of the invention provides for the control motors to be in the form of electric motors (PEM) with permanent magnet excitation, which are connected to a toothed rim via pinions. Electric motors with permanent magnet excitation have the advantage that they can emit a high torque even at low rotation speeds. The use of relatively small, space-saving motors is thus advantageously possible. Appropriate electric motors with permanent magnet excitation are known, for example, from machine tool construction.

A further refinement embodiment of the invention provides for the control motors to be in the form of transmission motors, with the transmissions having an output pinion. It is thus advantageously possible to use commercially available three-phase motors, in which case the additional space required for the transmission is not very significant. Irrespective of whether electric motors with permanent magnet excitation or conventional three-phase motors with transmissions connected to their flanges are used, the electric control motors are so small that they can be arranged in the shaft upper part without major difficulties. This results in a considerable reduction in the physical height of the control drive, so that the cargo area above the steering propeller can be utilized better than in the past.

It is particularly advantageous for the operation of the steering propeller if the control motors are designed such that they can apply a permanent torque. This makes it possible for the at least two electric rotary motors to act in opposite senses, and thus to be used to brace the toothed rim. There is therefore no need for any additional fixing brake for the shaft, and oscillation damping for the shaft can even be provided by means of a suitable electrical drive.

The pressure fields which are produced by the propellers result in a permanent stimulus to the shaft. In particular, this occurs in the case of electric steering propellers with tractor and propellers or with a tractor propeller, since the electrical steering propellers require a shaft with a large cross section. In this case, the bracing in opposite senses provided by the at least two control motors reliably avoids knocking of the pinions, and there is no need for a brake.

It is particularly advantageous if the control motors can be controlled and regulated in accordance with characteristics. This allows the control motors to be started softly when carrying out control movements, with one of the control motors providing a driving effect, for example, and the other a braking effect - with a low torque, of course. The use of characteristic regulation in this case particularly advantageously makes it possible to make use of the dynamic characteristics in particular of electrical steering propellers with two propellers which require control forces of different magnitudes to carry out a uniform rotary movement in a particular manner and depending on the position during swiveling due to the different downstream flow in different areas of the ship's stern.

The control motors advantageously have rotation speed and rotation direction measurement devices. The precise position of the shaft can thus be detected using simple counters, and there is no need for an additional rotation position sensor system.

The control drive is advantageously connected to the electrically/electronically operating ship's propulsion system. It is thus possible to influence the control drive directly via the ship's propulsion system. The ship's propulsion system in this case advantageously has memory devices with optimum curves, possibly also limit curves, which make it possible to take account of the relationship between the rotation speed of the steering propellers and the ship's velocity and/or the instantaneous position of the steering propellers.

In particular, this makes it possible to avoid excessive rapid adjustments, which would lead to maneuvers that are not matched to the ship's velocity. It is known for electrical steering propellers to be provided with a harbor mode and with an open-sea mode. However, there are also a large number of other operating modes between these operating modes, and these must likewise be coped with safely. This can be done by the predetermined characteristic according to at least one embodiment of the invention.

At lest one embodiment of the invention also provides for the power supply units which are required to operate the control motors to have an uninterruptible power supply (UPS). This ensures that the control drives can be operated safely at all times. The control motors are advantageously supplied with power via intermediate circuit converters, with the intermediate circuits having a braking resistor. It is thus possible not only to start to rotate the shaft by way of the control drive, but also to end this rotation quickly and in a controlled manner.

The advantages of the control drive according to at lest one embodiment of the invention become particularly evident when driving a steering propeller which is equipped with two individual propellers at the ends. Controlling a drive such as this is particularly critical, so that the electrical direct drive proposed according to the invention with the capabilities for direct control and regulation via characteristics is particularly advantageous. Furthermore, the oscillation response of the steering propeller can also be influenced in an advantageous manner.

### BRIEF DESCRIPTION OF THE DRAWINGS

The invention will be explained in more detail with reference to the drawings and embodiments of the invention, which illustrate further details which are also significant to embodiments of the invention and in which, in detail:

FIG. 1 shows a steering propeller with its power supply devices, illustrated schematically,

FIG. 2 shows a particularly advantageous embodiment of the electrical circuit for four control motors,

FIG. 3 shows a linear characteristic for the torque profile, and

FIG. 4 shows a different characteristic profile for the torque.

### DETAILED DESCRIPTION OF THE PREFERRED EMBODIMENTS

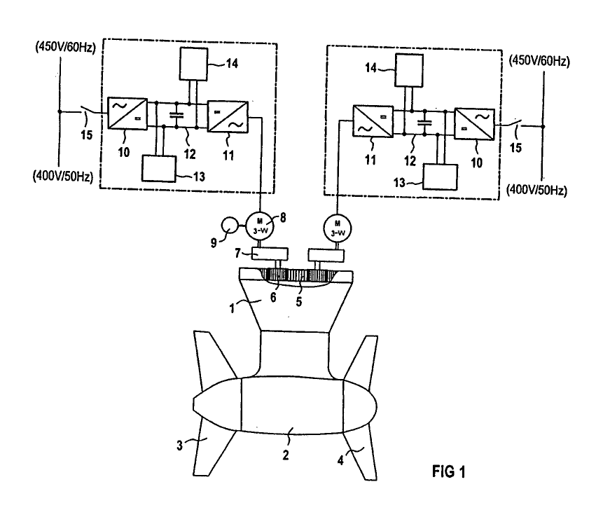

In FIG. 1, 1 denotes the shaft of a steering propeller and 2 denotes the housing of an electric motor which is fitted to the lower part of the steering propeller shaft 1. Element 3 denotes a propeller which is driven by the motor in the housing 2, and 4 denotes a second propeller, which is likewise driven by the motor in the housing 2. A preferably continuous motor shaft, which is not shown in any more detail, is located between the two propellers 3 and 4. Instead of the housing 2 for an electric motor, it is also possible to arrange the housing for a transmission for a mechanically driven steering propeller, in which case the drive shaft for the mechanically driven steering propeller and the shaft 1 can be designed to be appropriately thinner in the center of the shaft 1.

A toothed rim 5 which is advantageously formed with an internal tooth system is located in the upper part of the shaft 1 and is driven by pinions 6 via transmissions 7 by the electric motors 8. If particularly high-torque electric motors are used, such as PEM motors, there may be no need for the transmissions 7. It is then particularly simple to arrange the motors 8 within the upper part of the shaft 1. The motors 8 have revolution counters and revolution direction counters 9, via which the rudder position can be detected.

The control drive is connected to the ship's power supply system, which is optionally 400 V/50 Hz or 450 V/60 Hz. An intermediate circuit converter with the input part 10 and the output part 11 as well as the intermediate circuit 12 is supplied with power from the medium-voltage ship's power supply system via a switching element 15. A braking resistor 13 is advantageously fitted to the intermediate circuit 12. An uninterruptible power supply 14 is provided in case the ship's power supply system fails, and is advantageously connected to the DC intermediate circuit 12. This ensures that the rudder can be moved even if the ship's power supply system fails.

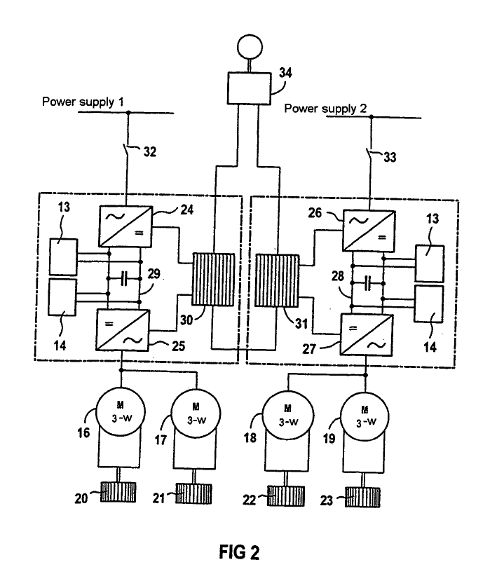

In FIG. 2, which shows a control drive with four motors, but which can also be provided with six, eight or even more motors for the control drive with the same circuit configuration, depending on the size of the ship and the tasks to be carried out by the ship, 16, 17, 18, 19 denote the four motors. These act on pinions 20, 21, 22, 23 which, in the illustrated embodiment, are in the form of normal toothed pinions. However, worm pinions or other mechanical elements can be used just as well. The motors are in each case supplied with power in groups of two from converters 24, 25 and 26, 27.

The motors can be actuated individually or in groups, in a manner which is not illustrated, so that it is possible for individual pinions to be braced to one another, to engage successively when rotary movements occur, and for a predetermined torque to be applied. The converters have intermediate circuits 28 and 29 and are supplied with electrical power by units 30 and 31 of uninterruptible power supplies, in an emergency. Instead of the uninterruptible power supply for the individual groups, it is also possible to use a joint uninteruptible power supply 34, such as that which exists, for example, for operation of the bridge. The individual groups are connected to the ship's power supply system by means of circuit breakers 32 and 33, preferably to a ship power supply system with a redundant configuration.

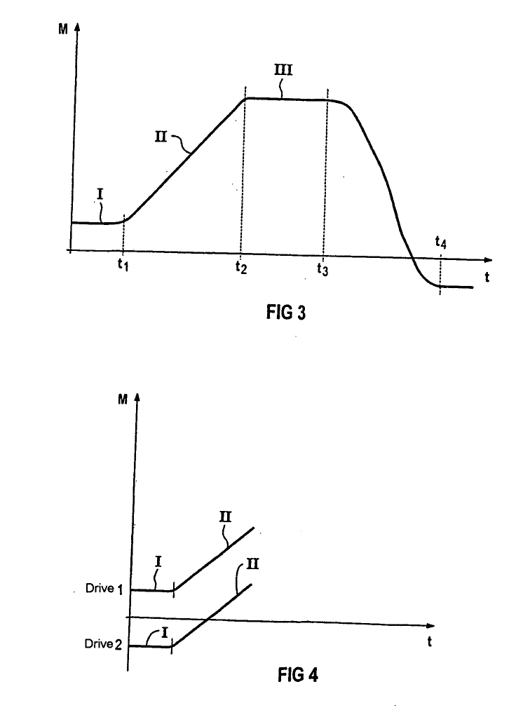

FIG. 3 shows a characteristic in its simplest form, with the area I indicating the permanently applied torque which prevents the possibility of the respective pinions knocking. Area II denotes the starting-up process with a constant increase in torque and area III denotes the drive torque when the electric motor has reached its rated rotation speed.

FIG. 4 shows a different characteristic, which results in the drive being started up particularly softly. In the section IV in FIG. 4, the increase in the torque is delayed continuously until the rated torque is reached.

The characteristics in FIGS. 3 and 4 should be regarded merely as examples, and it is self-evident that they are configured on a ship-specific basis and have other characteristics superimposed on them which are based on the rotation angle dependency of the torque to be applied. This takes account of the different incident flow conditions when the steering propeller is pivoted outward. This is particularly necessary when flow guidance bodies are arranged underneath the ship, which result in the incident flow to the steering propellers being slowed down in their flow shadow. In this case, when the steering propeller is pivoted outward, this results in changes in the rotation power that is required, which changes are dependent on speed and are advantageously counteracted by varying the torque from the motors.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A control drive for a steering propeller, in particular an electrically driven steering propeller, for a seagoing vessel which is arranged in the stern area on a shaft which can be rotated underneath the bottom of the ship, in which case the shaft can be rotated via at least two electric control motors which are designed such that they act via pinions on a toothed rim which is connected to the upper shaft part, preferably on a toothed rim which is arranged in the interior of the upper- shaft part, and for this purpose can be controlled and regulated jointly, and with the control motors being designed such that they can apply a permanent torque, and in which case the permanent torque from the at least two control motors can be applied such that they counteract one another, in order to brace the toothed rim.

2. The control drive as claimed in claim 1, characterized in that the control motors are in the form of electric motors (PEM) with permanent magnet excitation, which are connected to the toothed rim via pinions.

3. The control drive as claimed in claim 1 or 2, characterized in that the control motors are in the form of transmission motors, with the transmissions having an output pinion.

4. The control drive as claimed in claim 1, 2 or 3, characterized in that the control motors are arranged in the shaft upper part.

5. The control drive as claimed in one or more of the preceding claims, characterized in that the control motors can be controlled and regulated in accordance with characteristics.

6. The control drive as claimed in one or more of the preceding claims, characterized in that the control motors have rotation speed and rotation direction measurement devices.

7. The control drive as claimed in one or more of the preceding claims, characterized in that the control motors (8) have switching devices, controls and regulators, which are connected to an electrically/electronically operating ship propulsion system.

8. The control drive as claimed in claim 7, characterized in that control drive data is stored for the control drives, preferably as a function of the ship's velocity and the intended ship's turn angle, in particular in a nonvolatile memory.

9. The control drive as claimed in one or more of the preceding claims, characterized in that the power supply units which are required to operate the control motors have an uninterruptible power supply (14) (UPS).

10. The control drive as claimed in one or more of the preceding claims, characterized in that the control motors (8) can be supplied with power via voltage intermediate circuit converters (10, 11), and preferably have a braking resistor (13).

11. The control drive as claimed in one or more of the preceding claims, characterized in that the steering propeller that is to be rotated is designed to be essentially cylindrical and has a propeller at each of its ends, with the adjustment characteristics being optimized for this form.
